(19) United States
(12) Patent Application Publication
(10) Pub. No.: US 2006/0118480 A1
(43) Pub. Date: Jun. 8, 2006

(54) Fuel filter and manufacturing method thereof

(75) Inventor: Seizo Inoue, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/103,623

(22) Filed: Apr. 12, 2005

(30) Foreign Application Priority Data
Dec. 3, 2004 (JP) P2004-351261

(51) Int. Cl. B01D 35/28

(52) U.S. Cl. 210/450; 210/455; 210/483

(57) ABSTRACT

A fuel filter and a manufacturing method thereof with which it is possible to prevent deformation of a filter element due to swelling caused by fuel, vibration of the vehicle in which the fuel filter is installed, or fuel pulsation or thermal cycling of fuel, and damage to joining parts of the filter element and end plates. In a fuel filter according to the invention, a reinforcing member is fitted in an inner tube groove provided on an inner tube, circumferential direction end parts of a filter element are both fixed to the reinforcing member, and the axial ends of the filter element and the reinforcing member are joined to a pair of end plates.

### BACKGROUND OF THE INVENTION

This invention relates to a fuel filter for example serving an engine mounted in an automotive vehicle and used to remove foreign matter from a fuel such as gasoline supplied to this engine, and to a method for manufacturing the fuel filter.

Generally, fuel filters of this kind have a tubular filter element and a pair of facing end plates, and the tubular filter element is disposed so as to be sandwiched between the pair of end plates. Fuel to the engine is supplied to for example the outer side of the filter element, passes through the filter element, whereby foreign matter is removed from it, and is supplied from for example the inner side of the filter element to the engine.

For example in JP-A-11-82211, a fuel filter made by fixing the ends of a filter element to a pair of end plates with an adhesive is disclosed. As well as bonding together the fuel element and the pair of end plates, this adhesive seals them together so that fuel does not leak out from between them.

And in JP-UM-B-6-21542, a fuel filter made by bonding a filter element to a pair of end plates by thermal welding is disclosed.

However, whereas generally the filter element is made from a material based on pulp and the pair of end plates are made with a polyacetal resin, the bondability of a pair of end plates made with polyacetal resin is poor, and there has been the problem that due to swelling caused by fuel, vibration and thermal cycling of the vehicle, or shocks caused by fuel pulsation, the adhesive detaches from the filter element, unfiltered fuel leaks out from between the filter element and the end plates, and the filtering performance consequently falls.

And even in fuel filters in which the filter element and the pair of end plates are joined by thermal welding, there has been the problem that the rigidity of the filter element is low and deformation of this filter element causes the filtering performance to fall.

### SUMMARY OF THE INVENTION

This invention provides a fuel filter and a manufacturing method thereof with which it is possible to ameliorate these problems and increase filtering performance.

The invention provides a fuel filter includes a tubular filter member disposed around an axis, an inner tube disposed inside this filter member, and a pair of end plates disposed at the axis direction ends of the filter member and the inner tube, for filtering fuel with the filter member. The filter member includes at least one filter element disposed around the axis and at least one reinforcing member extending in the direction of the axis and holding the filter element. The inner tube has in its outer face an inner tube groove extending in the direction of the axis. The reinforcing member fits into the inner tube groove in the inner tube. The filter element has two circumferential direction end parts fixed to the reinforcing member. The axial ends of the filter element and the reinforcing member are joined to the pair of end plates.

Also, the invention provides a method for manufacturing a fuel filter includes a tubular filter member having at least one filter element disposed around an axis and at least one reinforcing member holding this filter element, an inner tube disposed inside the filter member and having in its outer face at least one inner tube groove extending in the direction of the axis, and a pair of end plates joined to the axial ends of the filter member and the inner tube. The manufacturing method including: a first step of assembling the filter member, a second step of assembling the inner tube to the filter member after this first step, and a third step of joining the pair of end plates to the filter member and the inner tube after the second step. In the first step the filter member is assembled by circumferential direction end parts of the filter element both being fixed to the reinforcing member. In the second step the inner tube is assembled to the inside of the filter element so that the reinforcing member fits in the inner tube groove. In the third step the pair of end plates are joined to the axial ends of the filter element and the reinforcing member and the inner tube.

In a fuel filter according to the invention, the filter member includes at least one filter element disposed around an axis and at least one reinforcing member, and the inner tube has in its outer face an inner tube groove extending in the direction of the axis. The reinforcing member fits into the inner tube groove in the inner tube, two circumferential direction end parts of the filter element are fixed to the reinforcing member, and the axial ends of the filter element and the reinforcing member are joined to a pair of end plates. Although the rigidity of the filter element is low, because its circumferential direction ends are both fixed to the reinforcing member, the filter element is strengthened. Consequently, the joining parts of the filter element and the pair of end plates are also strengthened, and it is possible to prevent incidents of these joining parts separating during filtering operation and fuel leaking out through the joining parts of the filter element and the end plates without passing through the filter element.

In a method for manufacturing a fuel filter according to the invention, in a first step, the circumferential direction end parts of a filter element around an axis are fixed to a reinforcing member. In a second step after this first step, the inner tube is assembled to inside the filter element so that the reinforcing member fits in the inner tube groove in the inner tube, and in a third step after that the axial ends of the filter element, the reinforcing member and the inner tube are joined to a pair of end plates. Consequently, when it is being joined to the pair of end plates the filter element is being strengthened by the reinforcing member, and deformation of the filter element can be prevented, and falling of the filtering performance caused by such deformation of the filter element can be prevented. And, the joining parts of the filter element and the pair of end plates are also strengthened, and it is possible to prevent incidents of these joining parts separating during filtering operation and fuel leaking out through the joining parts of the filter element and the end plates without passing through the filter element.

### BRIEF DESCRIPTION OF THE DRAWINGS

A number of preferred embodiments of the invention will now be described with reference to the accompanying drawings, in which:

FIG. 1 is a vertical sectional view showing a first preferred embodiment of a fuel filter according to the invention;

FIG. 2 is a sectional view on the line A-A in FIG. 1;

FIG. 3 is a perspective view showing an inner tube and a pair of end plates in the first preferred embodiment;

FIG. 4 is a sectional view showing a second preferred embodiment of a fuel filter according to the invention;

FIG. 5 is a sectional view showing a third preferred embodiment of a fuel filter according to the invention;

FIG. 6 is a partially sectional side view of a fourth preferred embodiment of a fuel filter according to the invention; and

FIG. 7 is a perspective view showing a reinforcing member in the fourth preferred embodiment.

### DETAILED DESCRIPTION OF THE PREFERRED EMBODIMENTS

A number of preferred embodiments of the invention will now be described with reference to the accompanying drawings.

### First Preferred Embodiment

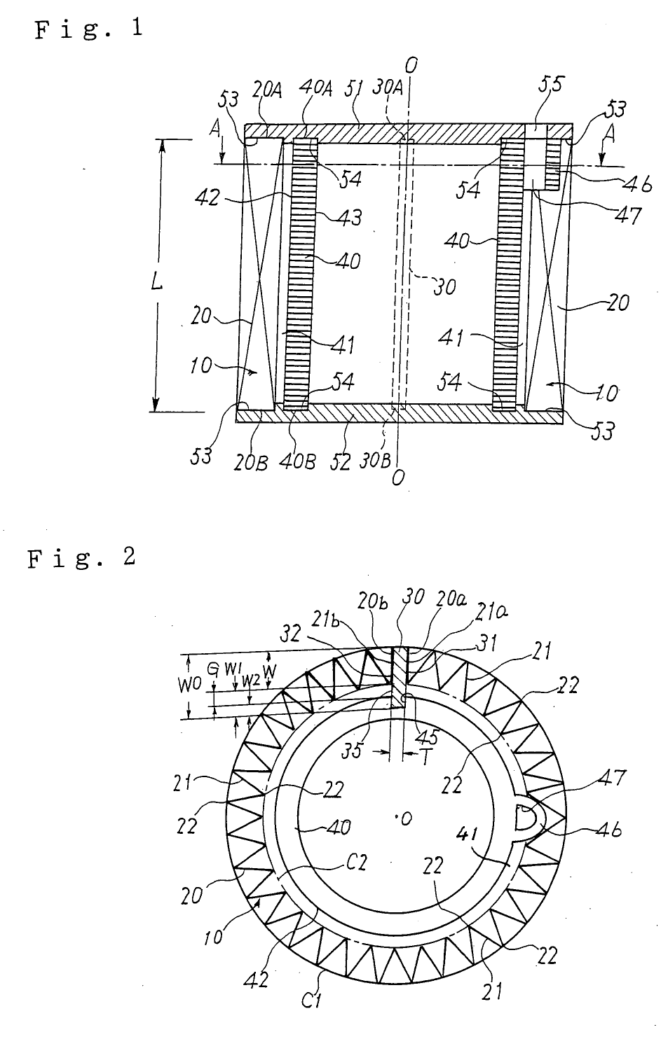

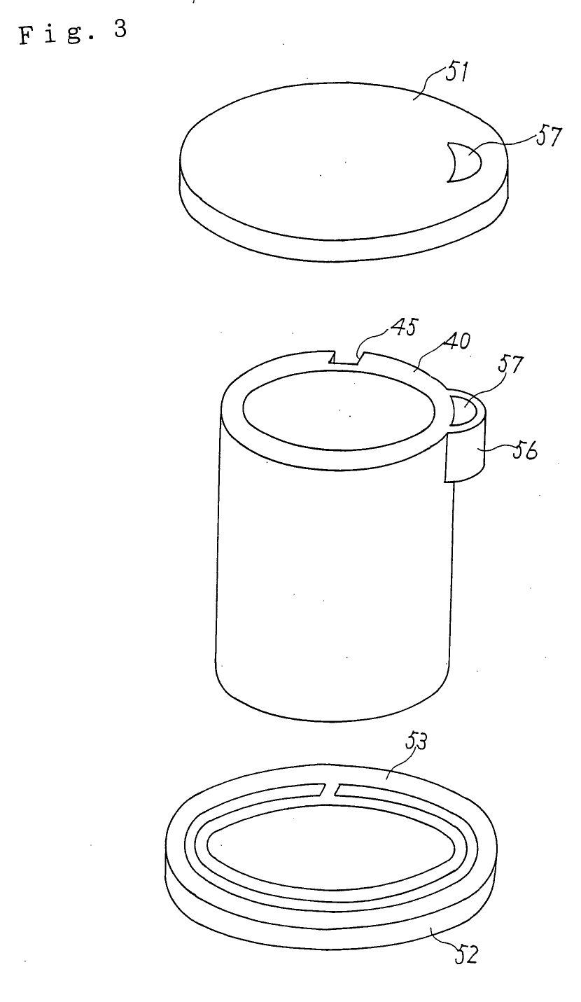

FIG. 1 is a vertical sectional view of a first preferred embodiment of a fuel filter according to the invention, FIG. 2 is a sectional view on the line A-A in FIG. 1, and FIG. 3 is a perspective view showing an inner cylinder and a pair of end plates of the fuel filter of the first preferred embodiment.

As shown in FIG. 1, the fuel filter of the first preferred embodiment has a filter member 10, an inner tube 40, and a pair of end plates 51, 52. The filter member 10 is made in the shape of a tube about an axis 0-0. The inner tube 40 is disposed on the inside of the filter member 10, and its center axis coincides with the axis 0-0. The pair of the end plates 51, 52 are joined to the top and bottom ends of the filter member 10 and the inner tube 40. The end plate 51 is a top end plate and the end plate 52 is a bottom end plate.

The fuel filter of the first preferred embodiment is mounted in for example a car, and filters a fuel such as gasoline being supplied to the engine of the car. The fuel is supplied to the outer side of the filter member 10 and flows through the filter member 10 to the inner side, and is supplied from the inner side of the filter member 10 to the engine. By the fuel passing through the filter member 10, foreign matter included in the fuel is removed.

As shown in FIG. 2, the filter member 10 includes one filter element 20 for filtering fuel, and one reinforcing member 30. The filter element 20 is for example made by forming a sheet consisting of a material made by adding a resin fiber such as polyester to a pulp into a chrysanthemum shape about the axis 0-0. This filter element 20 is made in a cylindrical shape between a circumscribing circle C1 centered on the axis 0-0 and an inscribing circle C2 centered on the axis 0-0.

The filter element 20 has two axial ends 20A, 20B in the direction of the axis 0-0, and the filter element 20 is made in a cylindrical shape in the space bounded by these axial ends 20A, 20B and the circumscribing circle C1 and the inscribing circle C2. Between the axial ends 20A, 20B, fuel passes through the filter element 20 from the circumscribing circle C1 side to the inscribing circle C2 side. The circumscribing circle C1 approximately coincides with the outer peripheries of the end plates 51, 52.

The filter element 20 has a plurality of long and narrow band-shaped sheetlike parts 21 and a plurality of fold parts 22. These sheetlike parts 21 and fold parts 22 extend in the direction of the axis 0-0 between the axial end 20A and the axial end 20B. The sheetlike parts 21 are each positioned between the circumscribing circle C1 and the inscribing circle C2, and the adjoining sheetlike parts 21 are connected to each other around the axis 0-0 by the adjacent fold parts 22. The fold parts 22 are positioned approximately on the circumscribing circle C1 and the inscribing circle C2.

The sheetlike parts 21 have a length L and a width W. The length L is the length in the direction of the axis 0-0 and is the length from the axial end 20A to the axial end 20B. The width W is the width between the circumscribing circle C1 and the inscribing circle C2. The length L and the width W are the same for all of the sheetlike parts 21.

The filter element 20 is disposed centering on and extending almost all the way around the axis 0-0, and has two circumferential direction end parts 20a, 20b formed at its ends in the circumferential direction. The circumferential direction end part 20a consists of an end sheetlike part 21a and the circumferential direction end part 20b consists of an end sheetlike part 21b. These end sheetlike parts 21a, 21b face each other sandwiching the reinforcing member 30 and are each fixed to the reinforcing member 30.

The reinforcing member 30 is a platelike member for reinforcing the filter element 20, which is low in rigidity. This reinforcing member 30 has a thickness T, a width W0 and a length L. The width W0 is a width in the radial direction centering on the axis 0-0, and this width W0 is larger than the width W of the sheetlike parts 21 of the filter element 20, i.e. W0>W. The length L of the reinforcing member 30 is its length in the direction of the axis 0-0, and this length L of the reinforcing member 30 is equal to the length L of the filter element 20. This reinforcing member 30 has two axial ends 30A, 30B in the axis 0-0 direction, and has first and second fixing faces 31 and 32. These first and second fixing faces 31, 32 extend in the axis 0-0 direction and face in opposite directions. This reinforcing member 30 is made for example by molding a resin material, for example polyacetal resin, into the shape of a plate.

The end sheetlike part 21a is fixed to the first fixing face 31 of the reinforcing member 30, and the end sheetlike part 21b is fixed to the second fixing face 32. These end sheetlike parts 21a, 21b are fixed to parts of the first and second fixing faces 31, 32 extending to the outer edges of the first and second fixing faces 31, 32. Specifically, the whole area of the end sheetlike part 21a is bonded, for example by thermal welding, parallel with the axis 0-0, to a part of the first fixing face 31 extending to the outer edge thereof. And similarly, the whole area of the end sheetlike part 21b is bonded, for example by thermal welding, to a part of the second fixing face 32 extending to the outer edge thereof. These end sheetlike parts 21a, 21b have their entire areas welded to the first and second fixing faces 31, 32 so that fuel does not leak between the reinforcing member 30 and the first and second fixing faces 31, 32.

At parts of the first and second fixing faces 31, 32 of the reinforcing member 30 extending to their inner edges there remain inner side areas 35 to which the end sheetlike parts 21a, 21b are not fixed, and these areas 35 have a width W1 in the radial direction from the axis 0-0. This width W1 is W1=W0−W.

The inner tube 40 is disposed on the inside of the filter element 20 and forms a fuel space 41 between itself and the filter element 20. Fuel having passed through the filter element 20 collects in this fuel space 41. The inner tube 40 is made in the shape of a cylinder from for example polyester resin. This inner tube 40 has two axial ends 40A, 40B and also has a circumferential outer face 42 and a circumferential inner face 43. The outer face 42 and the inner face 43 are formed between the axial ends 40A, 40B, and the fuel space 41 is formed between the axial ends 40A, 40B between the filter element 20 and the outer face 42 of the inner tube 40.

An inner tube groove 45 and a fuel delivery member 46 are formed on the outer face 42 of the inner tube 40. The inner tube groove 45 extends in the axis 0-0 direction between the axial end 40A and the axial end 40B. This inner tube groove 45 has a depth W2 and a width T. The depth W2 of the inner tube groove 45 is a depth in the radial direction centering on the axis 0-0, the width T is a width in the circumferential direction about the axis 0-0, and this width T of the inner tube groove 45 is equal to the thickness T of the reinforcing member 30. The inner side areas 35 of the reinforcing member 30 fit in this inner tube groove 45, and the reinforcing member 30 is thereby held by the inner tube groove 45.

As a result of the inner side areas 35 of the reinforcing member 30 being fitted in the inner tube groove 45, a gap G is set between the end sheetlike parts 21a, 21b fixed to the fixing faces 31, 32 of the reinforcing member 30 and the outer face 42 of the inner tube 40. This gap G is G=W1−W2. As a result of this gap G being set between the end sheetlike parts 21a, 21b and the outer face 42, a gap approximately equal in size to the gap G is formed between the inscribing circle C2 and the outer face 42 of the inner tube 40, and a gap approximately equal in size to the gap G is also formed between the multiple fold parts 22 positioned on the inscribing circle C2 and the outer face 42 of the inner tube 40. This gap between the fold parts 22 on the inscribing circle C2 and the outer face 42 of the inner tube 40 is effective in ensuring a flow of fuel inside the fuel space 41.

The fuel delivery member 46 is formed on a part of the outer face 42 adjacent to the upper axial end 40A of the inner tube 40. This fuel delivery member 46 has a fuel delivery opening 47 passing through it in the axis 0-0 direction. The fuel delivery member 46 is positioned inside the filter element 20 between two adjacent sheetlike parts 21, as shown in FIG. 2, and delivers fuel from inside the fuel space 41 out through the fuel delivery opening 47.

The top end plate 51 and the bottom end plate 52 are joined to the top and bottom ends of the filter member 10 and the inner tube 40 so as to sandwich them. The end plate 51 and the end plate 52 are circular plates both having the same diameter, and are made from a resin material, for example polyacetal resin. These end plates 51, 52 each have a fixing face 53, and the axial ends 20A, 20B of the filter element 20, the axial ends 30A, 30B of the reinforcing member 30 and the axial ends 40A, 40B of the inner tube 40 are joined to these fixing faces 53 by thermal welding.

As shown in FIG. 1 and FIG. 3, a fuel delivery hole 57 is formed in the top end plate 51. This fuel delivery hole 57 is formed in the same position as the fuel delivery opening 47, and is used to deliver fuel out from the fuel filter.

The joining parts of the axial ends 20A, 20B of the filter element 20 and the end plates 51, 52 are sealed so that fuel does not leak between the axial ends 20A, 20B of the filter element 20 and the end plates 51, 52. The joining parts of the axial ends 30A, 30B of the reinforcing member 30 and the end plates 51, 52 similarly are sealed so that fuel does not leak between the axial ends 30A, 30B of the reinforcing member 30 and the end plates 51, 52. These joining parts prevent fuel supplied to the outer side of the filter element 20 from leaking out to the fuel space 41 without passing through the filter element 20.

In this first preferred embodiment, the end sheetlike parts 21a, 21b of the circumferential direction end parts 20a, 20b of the filter element 20 are fixed to the first and second fixing faces 31, 32 of the reinforcing member 30, and the filter element 20 is thereby reinforced by the reinforcing member 30. Whereas otherwise there would be a risk of the filter element 20 deforming due to swelling caused by fuel, vibration and thermal cycling of the car, or shocks caused by fuel pulsation, and a risk of damage to the joining parts of the axial ends 20A, 20B of the filter element 20 and the end plates 51, 52, by means of the reinforcement provided by the reinforcing member 30 this kind of deformation and damage can be prevented, and dropping of the performance of the filter accompanying this kind of deformation and damage can be prevented. The fixed parts of the axial ends 40A, 40B of the inner tube 40 and the end plates 51, 52 stop leakage of fuel from the fuel space 41.

Next, a method for manufacturing the fuel filter of the first preferred embodiment will be described. This manufacturing method includes first through third manufacturing steps. The first step is a step of assembling the filter member 10, the second step is a step of assembling the inner tube 40 to the inside of the filter member 10 after the first step, and the third step is a step of joining the pair of end plates 51, 52 to the filter member 10 and the inner tube 40 after the second step.

In the first step, the filter member 10 is disposed extending almost all the way around the axis 0-0, and the reinforcing member 30 is disposed between the end sheetlike parts 21a, 21b. In this state, the whole area of the end sheetlike part 21a is thermally welded to the first fixing face 31 of the reinforcing member 30 by the first fixing face 31 of the reinforcing member 30 and the whole area of the end sheetlike part 21a being heated and the whole area of the end sheetlike part 21a being pressed against a part of the first fixing face 31 extending to the outer edge thereof. And, the second fixing face 32 of the reinforcing member 30 and the whole area of the end sheetlike part 21b are heated, and the whole area of the end sheetlike part 21b is thermally welded to the second fixing face 32 of the reinforcing member 30 by the second fixing face 32 of the reinforcing member 30 and the whole area of the end sheetlike part 21b being heated and the whole area of the end sheetlike part 21b being pressed against a part of the second fixing face 32 extending to the outer edge thereof. By this first step, the assembly of the filter member 10 is completed.

In the second step, the inner tube 40 is assembled to the inside of the filter member 10 so that the inner side areas 35 of the reinforcing member 30 fit in the inner tube groove 45 of the inner tube 40. The reinforcing member 30 is thereby held in the inner tube groove 45 of the inner tube 40.

In the third step, the end plates 51, 52 are disposed on the axis 0-0 ends of the filter member 10 and the inner tube 40. In this state, the axial end 20A of the filter element 20, the axial end 30A of the reinforcing member 30 and the axial end 40A of the inner tube 40, and the fixing face 53 of the end plate 51 facing these, are heated and pressed together and thereby thermally welded. And, the axial end 20B of the filter element 20, the axial end 30B of the reinforcing member 30 and the axial end 40B of the inner tube 40, and the fixing face 53 of the end plate 52 facing these, are heated and pressed together and thereby thermally welded. By this means, the end plates 51, 52 are joined to the ends of the filter element 20, the reinforcing member 30 and the inner tube 40.

In this manufacturing method, in particular, because the end plates 51, 52 are thermally welded to the axial ends 20A, 20B of the filter element 20 in the third step, after the filter element 20 is reinforced with the reinforcing member 30 in the first step, deformation of the filter element 20 resulting from it being joined to the end plates 51, 52 can be prevented. For example, whereas if the filter element 20 deforms at the joining parts of the axial ends 20A, 20B of the filter element 20 and the end plates 51, 52, the thermal welding at those joining parts becomes incomplete and fuel may leak out through those joining parts, in the manufacturing method of this first preferred embodiment such leakage of fuel at the joining parts an be surely prevented. And the filter performance falling due for example to two adjacent sheetlike parts 21 making contact with each other as a result of deformation of the filter element 20 can also be prevented.

### Second Preferred Embodiment

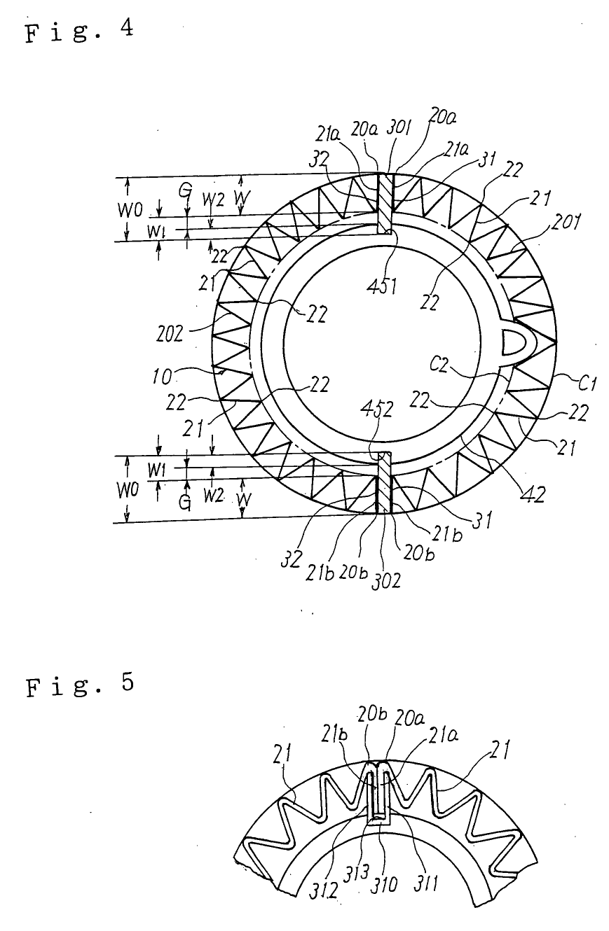

FIG. 4 is a sectional view showing a second preferred embodiment of a fuel filter according to the invention. This FIG. 4 is for the second preferred embodiment the same kind of sectional view of as FIG. 2.

Whereas in the first preferred embodiment the filter member 10 included one filter element 20 and one reinforcing member 30, in this second preferred embodiment the filter member 10 includes two filter elements 201, 202 and two reinforcing members 301, 302. The filter elements 201, 202 are each constructed in the same way as the filter element 20 in the first preferred embodiment, but differ in that they each are shaped so as to be disposed extending about half way around the axis 0-0.

Each of the filter elements 201, 202 has a plurality of band-shaped sheetlike parts 21 and a plurality of fold parts 22, like the filter element 20 in the first preferred embodiment, and approximately half the way around the axis 0-0 in each case the adjoining sheetlike parts 21 are connected to each other by the adjacent fold parts 22. The filter elements 201, 202, like the filter element 20 in the first preferred embodiment, each have circumferential direction end part 20a with an end sheetlike part 21a and a circumferential direction end part 20b with an end sheetlike part 21b.

The two reinforcing members 301, 302 are disposed in positions apart from each other by 180° around the axis 0-0. The reinforcing members 301, 302 are platelike members constructed in the same way as the reinforcing member 30 in the first preferred embodiment. The reinforcing members 301, 302, like the reinforcing member 30 in the first preferred embodiment, each have first and second fixing faces 31, 32. In this second preferred embodiment, the inner tube 40 has two inner tube grooves 451, 452, and these inner tube grooves 451, 452 are disposed in positions apart from each other by 180° in the outer face 42 of the inner tube 40. These inner tube grooves 451, 452 have the same shape as the inner tube groove 45 in the first preferred embodiment.

The filter element 201, in FIG. 4, is disposed in a semi-circle on the right side of the axis 0-0, between the reinforcing members 301, 302. The whole areas of the end sheetlike part 21a of the filter element 201 and the end sheetlike part 21b of the filter element 201 are fixed by thermal welding to the first fixing face 31 of the reinforcing member 301 and the first fixing face 31 of the reinforcing member 302 respectively. The filter element 202, in FIG. 4, is disposed in a semi-circle on the left side of the axis 0-0, between the reinforcing members 301, 302. The whole areas of the end sheetlike part 21a of the filter element 202 and the second fixing face 32 of the reinforcing member 301 are fixed by thermal welding to the second fixing face 32 of the reinforcing member 301 and the second fixing face 32 of the reinforcing member 302 respectively.

By the reinforcing members 301, 302 having their width W0, the width W1 of their inner side areas 35 to which the end sheetlike parts 21a, 21b are not attached, and the depth W2 of the inner tube grooves 451, 452 of the inner tube 40 set in the same way as in the first preferred embodiment, a gap G is formed between the inscribing circle C2 of the filter element 20 and the outer face 42 of the inner tube 40.

Because in the filter member 10 in this second preferred embodiment the filter elements 201, 202 are reinforced by two reinforcing members 301, 302, compared to the first preferred embodiment the reinforcing effect on the filter elements 201, 202 is multiplied.

A method for manufacturing a fuel filter according to the second preferred embodiment will now be described. The manufacturing method of this second preferred embodiment also includes first through third manufacturing steps. The first step is a step of assembling the filter member 10, the second step is a step of assembling the inner tube 40 to inside the filter member 10 after the first step, and the third step is a step of joining the pair of end plates 51, 52 to the filter member 10 and the inner tube 40 after the second step.

In the first step, the filter element 201 is disposed extending approximately half way around the axis 0-0, and the reinforcing members 301, 302 are disposed respectively facing the end sheetlike parts 21a, 21b of this filter element 201. In this state, the first fixing face 31 of the reinforcing member 301 and the whole area of the end sheetlike part 21a of the filter element 201 are heated, and first fixing face 31 of the reinforcing member 302 and the whole area of the end sheetlike part 21b of the filter element 201 are heated, and the whole area of the end sheetlike part 21a of the filter element 201 is pressed against a part of the first fixing face 31 of the reinforcing member 301 extending to the outer edge thereof, and the whole area of the end sheetlike part 21b of the filter element 201 is pressed against a part of the first fixing face 31 of the reinforcing member 302 extending to the outer edge thereof, whereby the whole areas of the end sheetlike parts 21a, 21b of the filter element 201 are thermally welded to the fixing faces 31 of the reinforcing members 301, 302. The filter element 201 is thereby fixed between the reinforcing members 301, 302 so as to be positioned in a semi-circle on the right side of the axis 0-0.

Then, the filter element 202 is disposed between the reinforcing members 301, 302 so as to be positioned in a semi-circle around the left side of the axis 0-0. In this state, the second fixing face 32 of the reinforcing member 301 and the whole area of the end sheetlike part 21a of the filter element 202, and the second fixing face 32 of the reinforcing member 302 and the whole area of the end sheetlike part 21b of the filter element 202 are heated, and the whole area of the end sheetlike part 21a of the filter element 202 is pressed against a part of the second fixing face 32 of the reinforcing member 301 extending to the edge thereof, and the whole area of the end sheetlike part 21b is pressed against a part of the second fixing face 32 of the reinforcing member 302 extending to the outer edge thereof, whereby the whole areas of the end sheetlike parts 21a, 21b of the filter element 202 are thermally welded to the second fixing faces 32 of the reinforcing members 301, 302. This first step completes the assembly of the filter member 10.

In the second step, the inner side areas 35 of the reinforcing member 301 and the inner side areas 35 of the reinforcing member 302 are fitted respectively in the inner tube groove 451 of the inner tube 40 and the inner tube groove 452 of the inner tube 40, whereby the inner tube 40 is assembled to the inside of the filter member 10. The reinforcing members 301, 302 are held by the inner tube grooves 451, 452 of the inner tube 40.

In the third step, the end plates 51, 52 are disposed at the ends of the filter member 10 and the inner tube 40. The axial ends 20A of the filter elements 201, 202, the axial ends 30A of the reinforcing members 301, 302 and the axial end 40A of the inner tube 40, and the fixing face 53 of the end plate 51 facing these, are heated, and these are pressed together and thereby thermally welded. The axial ends 20B of the filter elements 201, 202, the axial ends 30B of the reinforcing members 301, 302, and the axial end 40B of the inner tube 40, and the fixing face 53 of the end plate 52 facing these, are heated, and these are pressed together and thereby thermally welded. In this way, the end plates 51, 52 are joined to the ends of the filter elements 201, 202, the reinforcing members 301, 302 and the inner tube 40.

In this manufacturing method, in particular, because the end plates 51, 52 are thermally welded to the axial ends 20A, 20B of the filter elements 201, 202 in the third step, after the filter elements 201, 202 are reinforced with the reinforcing members 301, 302 in the first step, deformation of the filter elements 201, 202 resulting from them being joined to the end plates 51, 52 can be prevented. For example, whereas if the filter elements 201, 202 deform at the joining parts of the axial ends 20A, 20B of the filter elements 201, 202 and the end plates 51, 52 the thermal welding at those joining parts becomes incomplete and fuel may leak out through those joining parts, in the manufacturing method of this second preferred embodiment such leakage of fuel at the joining parts can be surely prevented. And the filter performance falling due for example to two adjacent sheetlike parts 21 making contact with each other as a result of deformation of the filter elements 201, 202 can also be prevented.

In the second preferred embodiment, the number of filter elements and reinforcing members may be further increased to three or more of each, and in this case, the reinforcing effect on the filter elements can be made still greater.

In the second preferred embodiment it is also possible to dispense with the filter element 202 and thermally weld one reinforcing member 302 to the middle of the filter element 201.

### Third Preferred Embodiment

FIG. 5 is a sectional view showing how a reinforcing member and filter elements used in a third preferred embodiment are fixed together. This FIG. 5 shows, in a sectional view equivalent to FIG. 2, how one reinforcing member 310 and end sheetlike parts 21a, 21b of two filter elements are fixed together.

The reinforcing member 310 used in this third preferred embodiment has an approximately U-shaped cross-section, and has a holding slot 313 formed between a pair of mutually facing holding arms 311, 312. The holding arms 311, 312 have a length L equal to the length L of the filter elements 20, 201, 202 along the axis 0-0, and thus the holding slot 313 also has the length L. The holding slot 313 opens outward, and the whole of both of the end sheetlike parts 21a, 21b of the filter element are fitted into the holding slot 313 and fixed there.

The reinforcing member 310 is made of a resin material, for example polyacetal resin, or a metal sheet. As the metal sheet, cold-rolled steel can be used. When the reinforcing member 310 is made of resin, first the end sheetlike parts 21a, 21b are thermally welded together and then the end sheetlike parts 21a, 21b are fitted in the holding slot 313 and the holding arms 311, 312 are heated and pressed toward each other to fix the whole of each of the end sheetlike parts 21a, 21b to the reinforcing member 310.

The axial ends 30A, 30B of the reinforcing member 310 are joined to a pair of end plates 51, 52. When the reinforcing member 310 is made of resin, the axial ends 30A, 30B are heated and thermally welded to heated fixing faces 53 of the end plates 51, 52. And when the reinforcing member 310 is made of metal sheet, the axial ends 30A, 30B are heated and slightly embedded in the heated fixing faces 53 of the end plates 51, 52.

The reinforcing member 310 used in the third preferred embodiment can be used as the reinforcing member 30 in the first preferred embodiment, and can be used as each of the two reinforcing members 301, 302 reinforcing members 301, 302 in the second preferred embodiment.

### Fourth Preferred Embodiment

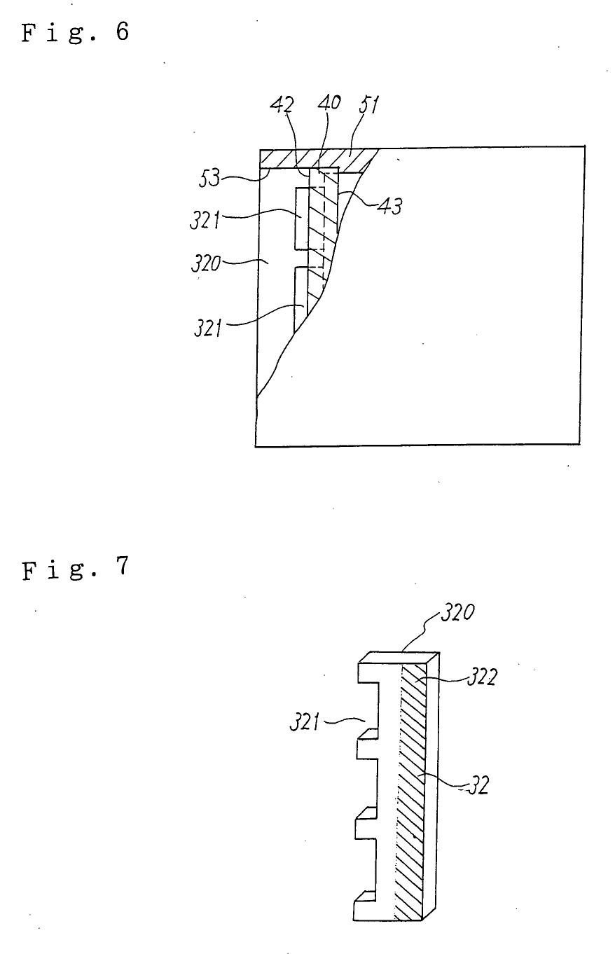

FIG. 6 is a partially sectional side view of a fourth preferred embodiment of a fuel filter according to the invention, and FIG. 7 is a perspective view showing a reinforcing member in the fourth preferred embodiment.

In this fourth preferred embodiment, a reinforcing member 320 made by improving the reinforcing member 30 of the first preferred embodiment is used. Compared to the reinforcing member 30 of the first preferred embodiment, this reinforcing member 320 is different in the point that a plurality of fuel passage openings 321 are formed in the inner side areas 35. Otherwise, it is constructed in the same way as the reinforcing member 30 in the first preferred embodiment. The inner side areas 35 of the reinforcing member 320 fit in the inner tube groove 45 of the inner tube 40, but the fuel passage openings 321 are formed more deeply than the depth W2 of this inner tube groove 45 in the inner tube 40. These fuel passage openings 321 pass all the way through the reinforcing member 320 in the fuel space 41, and have an effect of making it possible for fuel to flow in the circumferential direction. In FIG. 7, the area 322 shown with hatching is the area over which the end sheetlike part 21a or 21b is fixed to the second fixing face 32.

The improved reinforcing member 320 in the fourth preferred embodiment can be used as the reinforcing member 30 in the first preferred embodiment and can also be used as each of the reinforcing members 301, 302 in the second preferred embodiment.

### Fifth Preferred Embodiment

Whereas in the first and second preferred embodiments the filter elements 20, 201 and 202 were made by folding into the shape of a chrysanthemum a sheet consisting of a material made by adding a resin fiber such as polyester resin to a pulp, in this fifth preferred embodiment the filter elements 20, 201 and 202 are made from a sheet of thickness not greater than 0.4 mm consisting of a material made by further adding 5 to 20% of a glass fiber to a material made by adding a resin fiber such as polyester to a pulp. When glass fiber is further added like this, because the rigidity of the filter element increases and it becomes harder to deform, deformation or damage of the parts joined to the end plates 51, 52, when the filter element is being joined to the end plates, or due to swelling caused by fuel during operation, vibration and thermal cycling of the car, or shocks caused by fuel pulsation, can be prevented, and when the filter element is being joined to the end plates 51, 52, deformation such that two adjacent sheetlike parts 21 make contact with each other can also be prevented.

A fuel filter according to this invention is useful for example as a fuel filter mounted in an automotive vehicle for supplying a fuel such as gasoline to an engine.

What is claimed is:

1. A fuel filter comprising a tubular filter member disposed around an axis, an inner tube disposed inside this filter member, and a pair of end plates disposed at the axis direction ends of the filter member and the inner tube, for filtering fuel with the filter member, wherein:
the filter member includes at least one filter element disposed around the axis and at least one reinforcing member extending in the direction of the axis and holding the filter element;
the inner tube has on its outer face an inner tube groove extending in the direction of the axis;
the reinforcing member fits into the inner tube groove of the inner tube;
the filter element has two circumferential direction end parts fixed to the reinforcing member; and
the axial ends of the filter element and the reinforcing member are joined to the pair of end plates.

2. The fuel filter according to claim 1, wherein the pair of end plates are made of resin and the axial ends of the filter element and the reinforcing member are thermally welded to the pair of end plates.

3. The fuel filter according to claim 1, wherein the filter member includes one filter element and one reinforcing member, and the one filter element is disposed extending almost all the way around the axis and has its circumferential direction end parts both fixed to the one reinforcing member.

4. The fuel filter according to claim 3, wherein the filter element has a plurality of long and narrow band-shaped sheetlike parts and a plurality of fold parts extending in the direction of the axis, the adjoining sheetlike parts of the sheetlike parts are connected to each other around the axis by the fold parts, the reinforcing member is a plate member extending in the direction of the axis and has first and second fixing faces on opposite sides of it, and the first end sheetlike part of the sheet like parts is fixed to the first fixing face and the second end sheetlike part of the sheetlike parts of the filter element is fixed to the second fixing face.

5. The fuel filter according to claim 3, wherein the filter element has a plurality of long and narrow band-shaped sheetlike parts and a plurality of fold parts extending in the direction of the axis, the adjoining sheetlike parts of the sheetlike parts are connected to each other around the axis by the fold parts, the reinforcing member has a holding groove extending in the direction of the axis, and the first and second end sheetlike parts of the sheetlike parts positioned at the circumferential direction ends of the filter element are both inserted and fixed in the holding groove.

6. The fuel filter according to claim 1, wherein the filter member includes first and second filter elements and first and second reinforcing members, the first and second reinforcing members are disposed in positions apart by approximately 180° around the outer face of the inner tube, each of the first and second filter elements is disposed extending around approximately half of the outer face of the inner tube between the first and second reinforcing members, and the circumferential direction end parts of the first and second filter elements are fixed to the first and second reinforcing members.

7. The fuel filter according to claim 6, wherein each of the first and second filter elements has a plurality of long and narrow band-shaped sheetlike parts and a plurality of fold parts extending in the direction of the axis, the adjoining sheetlike parts of the sheetlike parts are connected to each other around the axis by the fold parts, each of the first and second reinforcing members is a plate member extending in the direction of the axis and has first and second fixing faces on opposite sides of it, the first end sheetlike part of the sheetlike parts of the first filter element is fixed to the first fixing face of the first reinforcing member and the first end sheetlike plate of the sheetlike parts of the second filter is fixed to the second fixing face of the first reinforcing member, and the second end sheetlike part of the sheetlike parts of the first filter element is fixed to the first fixing face of the second reinforcing member and the second end sheetlike part of the sheetlike parts of the second filter element is fixed to the second fixing face of the second reinforcing member.

8. The fuel filter according to claim 6, wherein each of the first and second filter elements has a plurality of long and narrow band-shaped sheetlike parts and a plurality of fold parts extending in the direction of the axis, the adjoining sheetlike parts of the sheetlike parts are connected to each other around the axis by the fold parts, each of the first and second reinforcing members has a holding groove extending in the direction of the axis, the first end sheetlike part of the sheetlike parts of the first filter element and the first end sheetlike part of the sheetlike parts of the second filter element are both inserted and fixed in the holding groove of the first reinforcing member, and the second end sheetlike part of the sheetlike parts of the first filter element and the second end sheetlike part of the sheetlike parts of the second filter element are both inserted and fixed in the holding groove of the second reinforcing member.

9. The fuel filter according to claim 1, wherein the reinforcing member has an opening for fuel to pass through on the inner side of the filter element.

10. The fuel filter according to claim 1, wherein the filter element has a plurality of long and narrow band-shaped sheetlike parts and a plurality of fold parts extending in the direction of the axis, the adjoining sheetlike parts of the sheetlike parts are connected to each other around the axis by the fold parts, and sheetlike parts positioned at the circumferential direction ends of the filter element are fixed to the reinforcing member in such a way as to form a gap between themselves and the outer face of the inner tube.

11. The fuel filter according to claim 1, wherein the filter element comprises a material made by further adding 5 to 20% of a glass fiber to a material made by adding a resin fiber to a pulp.

12. A method for manufacturing a fuel filter comprising a tubular filter member including at least one filter element disposed around an axis and at least one reinforcing member holding this filter element, an inner tube disposed inside the filter member and having on its outer face at least one inner tube groove extending in the direction of the axis, and a pair of end plates joined to the axial ends of the filter member and the inner tube, the manufacturing method comprising:
a first step of assembling the filter member, a second step of assembling the inner tube to the filter member after this first step, and a third step of joining the pair of end plates to the filter member and the inner tube after the second step, wherein
in the first step the filter member is assembled by circumferential direction end parts of the filter element both being fixed to the reinforcing member,
in the second step the inner tube is assembled to the inside of the filter element so that the reinforcing member fits into the inner tube groove, and
in the third step the pair of end plates are joined to the axial ends of the filter element and the reinforcing member and the inner tube.

13. The method for manufacturing a fuel filter according to claim 12, wherein the filter member includes one filter element and one reinforcing member, and in the first step the filter member is assembled by the one filter element being disposed extending almost all the way around the axis and its circumferential direction end parts being fixed to the one reinforcing member.

14. The method for manufacturing a fuel filter according to claim 12, wherein the filter member includes two reinforcing members disposed apart from each other by approximately 180° around the axis and two filter elements, and in the first step the filter member is assembled by the two filter elements each being disposed extending approximately half way around the axis between the two reinforcing members and circumferential direction end parts of the two filter elements being fixed to the two reinforcing members.
